(19) United States
(12) Patent Application Publication
(10) Pub. No.: US 2013/0069268 A1
(43) Pub. Date: Mar. 21, 2013

(54) Non-Uniform Color Infusion Distribution In Plastic Containers

(71) Applicants: Wei Liu, Pittsburgh, PA (US); Lee M. Nicholson, Katonah, NY (US)

(72) Inventors: Wei Liu, Pittsburgh, PA (US); Lee M. Nicholson, Katonah, NY (US)

(73) Assignee: PepsiCo, Inc., Purchase, NY (US)

(21) Appl. No.: 13/234,872

(22) Filed: Sep. 16, 2011

(51) Int. Cl. B29C 47/06

(52) U.S. Cl. 264/75

(57) ABSTRACT

One or more colorants are infused into thermoplastic materials in a randomized pattern to create a unique visual effect in a plastic preform or container. The visual effect may be similar to that of a drop of dye diffusing in water and forming a ribbon pattern. In some embodiments, a desired infusion effect may be achieved by generating inconsistent loading of a colorant-containing intermediate layer to achieve ribbons or swirls of color throughout the preform or a portion thereof.

### BACKGROUND

Current polyethylene terephthalate (PET) beverage containers typically are clear or uniformly shaded with minimum amount of colorants, such as color-pigments, effects pigments, or dyes. Some techniques have been proposed to prepare multi-colored preforms and containers, generally involving the formation of two or more discrete colored regions. For example, Dierickx U.S. 2010/0307633 A1 describes a blow molded polychromatic container having a seamless and uninterrupted transition between primary and secondary colored materials. Abe et al. U.S. 2008/0317989 A1 discloses an injection molded bottle having an embedded colored layer which exhibits a gradual decrease in thickness to achieve a similar visual effect.

Containers having enhanced visual appeal may help to gain customer attention and influence purchasing decisions. It would be desirable to prepare plastic containers with unique visual characteristics, especially containers that may be prepared by injection blow molding techniques using existing machinery and requiring no more than minimum modifications.

### SUMMARY

In one aspect, one or more colorants are infused into thermoplastic materials in a randomized pattern to create a unique (e.g., non-repeatable) visual effect in a plastic preform or container. A preform or container may have non-uniformly distributed patterns of one or more colors. In some embodiments, the visual effect is similar to that of a drop of dye diffusing in water and forming a ribbon pattern. The visual effect may not only lead to enhanced shelf presence, but may also favorably influence consumer purchasing decisions.

In some aspects, a desired infusion effect may be achieved by generating inconsistent loading of a colorant-containing intermediate layer to achieve ribbons or swirls of color throughout the preform. A multilayer structure may include, for example, a three-layer structure with A/B/A layers. A main extruder may carry the “A” material and a secondary extruder the intermediate “B” material. The “B” layer may be inserted into the melt of the “A” layer near the nozzle through a manifold.

The “A” layer may be a thermoplastic material, such as PET, and may be clear or contain one or more colorants. The intermediate “B” layer may be a thermoplastic material, such as PET, containing one or more colorants. The injection speeds, dosage volume, and/or timing that the intermediate “B” layer is inserted may be varied to achieve the desired visual effects. In some cases, the intermediate layer has thickness variation and/or an uneven flow front. For some visual effects, colorant may be added into a single shot of the “A” layer so that it bleeds into and out of the preforms somewhat inconsistently. Using these different techniques, it is possible to prepare preforms and containers that exhibit one or more unique color fusion effects.

### BRIEF DESCRIPTION OF THE DRAWINGS

FIG. 1 shows examples of preforms and containers having randomized visual effects formed by adding a single shot of colorant into the “A” layer of an A/B/A structure.

FIG. 2 shows a three layer preform and blown bottle, in which the outer layers are clear PET and the intermediate layer includes translucent blue colorant (1.5%) diffused in the upper body portion.

FIG. 3 shows a three layer preform and blown bottle, in which the outer layers are clear PET and the intermediate layer includes translucent blue colorant (1.5%) diffused in the mid body portion.

FIG. 4 shows a three layer preform and blown bottle, in which the outer layers are clear PET and the intermediate layer includes translucent blue colorant (1.5%) diffused in the upper portion with wavy bands.

FIG. 5 shows three layer preforms and blown bottles, in which the outer layers are PET containing 0.12 g white colorant (0.5%) added every 8 parts, and the intermediate layer includes translucent blue colorant (1.5%) diffused in the upper portion with wavy bands.

FIG. 6 shows a three layer preform and blown bottle, in which the outer layers are clear PET and the intermediate layer includes translucent blue colorant (3%) diffused in a tight diagonal band in the shoulder.

FIG. 7 shows a three layer preform and blown bottle, in which the outer layers are PET containing transparent green liquid colorant (0.04%) and the intermediate layer includes translucent blue colorant (1.5%) diffused in the upper portion with wavy bands.

FIG. 8 shows a three layer preform and blown bottle, in which the outer layers are PET containing transparent green liquid colorant (0.04%) and the intermediate layer includes translucent blue colorant (12%) diffused in a swirl pattern.

FIG. 9 shows a three layer preform and blown bottle, in which the outer layers are clear PET and the intermediate layer includes translucent blue colorant (6%) diffused in the upper body portion.

FIG. 10 shows a three layer preform and blown bottle, in which the outer layers are clear PET and the intermediate layer includes translucent blue colorant (8%) diffused in the mid body portion.

FIG. 11 shows a three layer preform and blown bottle, in which the outer layers are clear PET and the intermediate layer includes translucent blue colorant (12%) diffused in the mid and upper body portions.

FIG. 12 shows a three layer preform and blown bottle, in which the outer layers are clear PET and the intermediate layer includes translucent blue colorant (12%) diffused in rings.

FIG. 13 shows a three layer preform and blown bottle, in which the outer layers are clear PET and the intermediate layer includes translucent blue colorant (12%) diffused in a swirled pattern in mid and upper body portions.

FIG. 14 shows a three layer preform and blown bottle, in which the outer layers are PET containing 4.5% blue colorant, and the intermediate layer includes white colorant (6%) diffused in a swirled pattern.

### DETAILED DESCRIPTION

The invention will be described primarily with reference to preparing injection-molded preforms, which are blow-molded into beverage containers. It should be recognized, however, that the techniques described herein may be used in the preparation of other types of containers, such as jars, tubs, trays, or bottles for holding foodstuffs or liquid. These types of polymeric containers may be prepared from one or more thermoplastic materials, non-limiting examples of which include polyethylene terephthalate (PET) or other thermoplastic polyesters such as polyethylene 2,6- and 1,5-naphthalate (PEN), PETG, polytetramethylene 1,2-dioxybenzoate, and copolymers of ethylene terephthalate and ethylene isophthalate; polyolefins such as polypropylene and polyethylene, as well as other materials derived from petroleum such as polystyrene, and the like. Of these, PET is most commonly used. The polymeric materials may include, in whole or in part, virgin polyester, recycled polyester, and/or co-polyesters, with or without conventional additives such as mold release agents and the like.

In general, preforms as described herein may be prepared by co-extruding at least two thermoplastic materials to form a multi-layered structure, e.g., having two or more layers, which is thereafter injection-molded into a shape similar to a test tube. The preform is subsequently stretched and blow-molded to form a container using well known techniques. A colorant is present in at least a second thermoplastic material to achieve the randomized visual effects described herein. A first thermoplastic material may be clear or may contain one or more colorants. For ease of description, the colorant-containing layer which is principally responsible for achieving the unique visual effects described herein will be referred to as the second thermoplastic material. In some embodiments, the first and second thermoplastic materials are co-extruded to form a three-layered structure of the configuration A/B/A. The intermediate “B” layer may be either the second thermoplastic material or the first thermoplastic material. Additional layers also may be present, such as gas barrier layers or the like. The structure may include two, three, four, five, or more layers, and there is no particular upper limit on the number of layers that may be present.

In some embodiments, the randomized visual effects may be achieved by generating inconsistent loading of the second thermoplastic material to achieve ribbons of color throughout the preforms. For example, the injection process may be set up to create an uneven flow front for the second layer to create visual disruptions, ribbons, and/or swirls of color. The injection parameters which may be varied include dosage volume of the thermoplastic material, injection speed, and injection timing. Unlike conventional injection molding where uniformity is an objective, the second thermoplastic material is injected in a way which is aimed at introducing a level of randomness to achieve a unique visual effect that is essentially non-reproducible. In some cases the visual effect can be likened to a drop a dye diffusing in water, creating a ribbon or swirl pattern. In general, the color(s) contributing to the visual effect are characterized by “organic” or non-geometric boundaries.

A variety of colorants, e.g., pigments, dyes, or the like, may be used to achieve the desired visual effects. Colorants may be used alone or in combination with other colorants to introduce randomized visual effect(s) as described herein. In general, colorants should be selected and used in loadings that are compatible with processing of the base polymer. Non-limiting examples of colorants include transparent blue: Solid PET Masterbatch colorant (Penn Color #66S 2484); white: Solid PET Masterbatch colorant (PolyOne Color #CC10084837WE); cyan: Solid PET Masterbatch colorant (Penn Color #66S 2485); transparent green: liquid colorant (ColorMatrix #184-10223-1); and opaque green: Solid PET Masterbatch (Ampacet Color #774266). These materials are merely given by way of example, as a wide variety of colorants conventionally used for plastics may be used without departing from the spirit or scope of the invention.

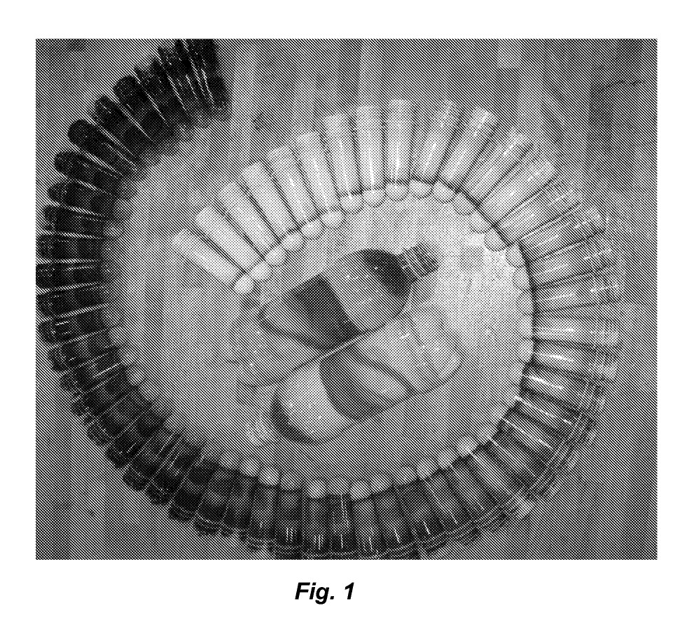

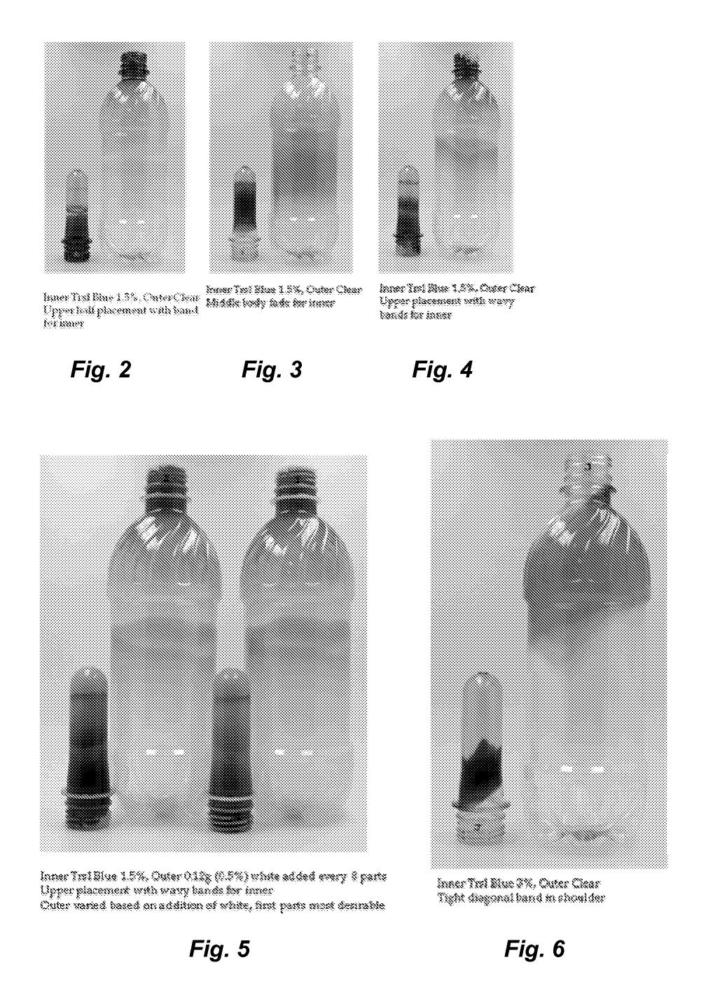

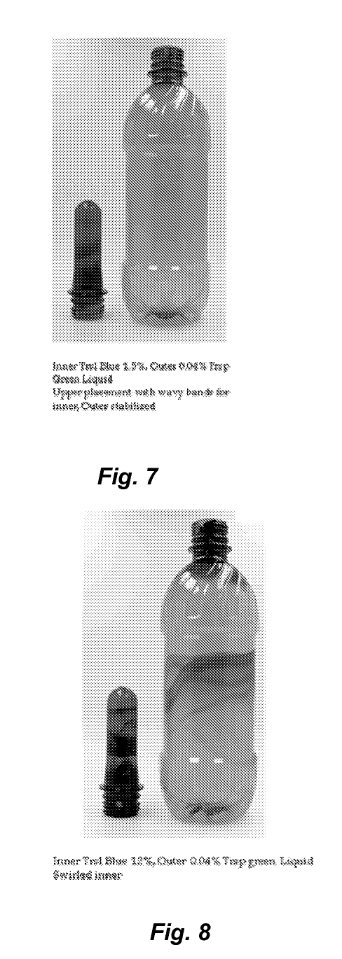

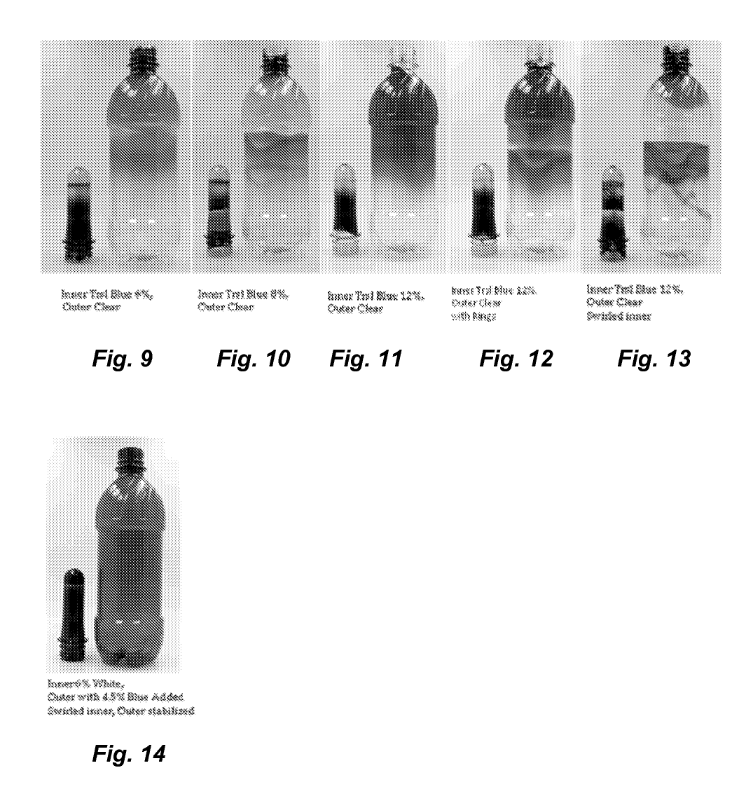

FIGS. 1-14 illustrate a variety of visual effects that may be achieved in a preform or container having a three-layer structure with an A/B/A configuration. Several of the preforms and containers used translucent blue colorant in the intermediate (“B”) layer to create a swirl pattern (see FIGS. 2-6 and 9-13). In some embodiments, green colorant was added over the swirled blue color on the intermediate layer (see FIGS. 7 and 8). Some samples were molded using white colorant on the intermediate layer (see FIG. 14) or added intermittently over the blue intermediate layer in clear and green PET. In other embodiments, a clear material is used for the intermediate layer, and blue and white colorants are added to the outer layer. FIG. 1 shows examples of preforms and containers having randomized visual effects formed by adding a single shot of blue colorant into the “A” layer of an A/B/A structure.

To a large extent, visual effect(s) present in a preform are retained during blow molding such that the resulting container has the same or corresponding visual effects. However, as can be seen in certain drawings figures, visual effects present in a preform are not always retained following blow molding. In some cases, differences in visual effects between the preform and the blown container may occur due to changes in physical properties, such as thickness, that may influence light transmission properties. Nevertheless, it was found that injection parameters can be controlled such that nearly all of the resulting preforms and containers have aesthetically desirable visual effects.

The thickness of the preform and container usually is constant, at least within a given region (e.g., neck/finish, body, base). The thickness of the individual layers typically is substantially constant throughout the preform/container or regions thereof. If desired, a thickness gradation may be present in the article or region(s) thereof, or within individual layers. Where individual layers have a non-constant thickness, e.g., for achieving visual effects or other properties, the individual layer thicknesses may be varied in a manner such that the total thickness (sum of layer thicknesses) remains constant in the preform or container, or within a region thereof.

### Example

The following example illustrates varying injection speed, dosage volume, and timing during injection molding to prepare standard sized preforms and containers having unique visual effects as illustrated in FIGS. 2-14. A first main extruder and a secondary extruder having manifolds configured to form a three-layered (“A/B/A”) structure was used to inject a PET outer (“A”) layer and an intermediate (“B”) layer of PET containing colorant(s) as indicated. Table 1 below summarizes the parameters used for injection molding of the “A” and “B” layers. The preforms were subsequently blow molded into containers under standard blow molding conditions.

TABLE I
Injection Set Up

| | |
|---|---|
| Preform Weight (g) | 20-25 |
| Mold Temp (° F.) | Between dew point and room temp. |
| Ambient Temp (° F.) | 72 |
| Cycle Time (sec) | 35-45 |
| A layer Parameters: | |
| Barrel Temperatures | |
| Feed Zone (° C.) | Melt T + 15° |
| Zone 2 (° C.) | > Feed Zone |
| Zone 3 (° C.) | > Zone 2 |
| Zone 4 (° C.) | > Zone 3 |
| Nozzle (° C.) | Same as Zone 4 |
| Injection | |
| 1st Injection Pressure (kbar) | ~1 |
| 2nd Injection Pressure (kbar) | ~1 |
| Injection Time (sec) | 1-3 |
| 1st Injection Speed (ccm/sec) | 10-20 |
| 2nd Injection Speed (ccm/sec) | 5-15 |
| Holding Pressure | |
| Switch-over Volume (ccm) | 5-10 |
| 1st Hold Pressure (bar) | ~450 |
| 2nd Hold Pressure (bar) | ~400 |
| 3rd Hold Pressure (bar) | ~400 |
| 4th Hold Pressure (bar) | ~300 |
| 1st Hold Pr. Time (sec) | none |
| 2nd Hold Pr. Time (sec) | <5 |
| 3rd Hold Pr. Time (sec) | <5 |
| 4th Hold Pr. Time (sec) | <5 |
| Remain Cool Time (sec) | ~20 |
| Dosage | |
| Circumf. Speed (m/min) | ~10 |
| Back Pressure (bar) | ~25 |
| Shot Volume (ccm) | 20-30 |
| Meas. Dosage Time (sec) | 2-4 |
| B layer Parameters: | |
| Barrel Temperatures | |
| Feed Zone (° C.) | ~25° higher than melt T |
| Zone 2 (° C.) | ~25° higher than melt T |
| Zone 3 (° C.) | ~25° higher than melt T |
| Zone 4 (° C.) | ~25° higher than melt T |
| Injection | |
| 1st Injection Pressure (kbar) | ~1 |
| Injection Time (sec) | <1 |
| 1st Injection Speed (ccm/sec) | 4-8 |
| Dosage | |
| Circumf. Speed (m/min) | 5-20 |
| Back Pressure (bar) | 20-30 |
| Shot Volume (ccm) | 1-3 |
| Meas. Dosage Time (sec) | 1-15 |

The foregoing description should be considered illustrative rather than limiting. It should be recognized that various modifications can be made without departing from the spirit or scope of the invention as described and claimed herein.

What is claimed:

1. A process of preparing a preform having at least one randomized visual effect, the process comprising:
co-extruding a first thermoplastic material and a second thermoplastic material to form a multi-layered structure, wherein the second thermoplastic material contains at least one colorant;
varying at least one of speed, dosage volume, and timing of injection of the second thermoplastic material so as to form a ribbon or swirl pattern; and
molding the multi-layered structure to form a preform having at least one randomized visual effect.

2. The process of claim 1 wherein a layer of the second thermoplastic material is extruded between adjacent layers of the first thermoplastic material to form a three-layer structure.

3. The process of claim 1 wherein a layer of the first thermoplastic material is extruded between adjacent layers of the second thermoplastic material to form a three-layer structure.

4. The process of claim 1 wherein the first thermoplastic material is clear.

5. The process of claim 1 wherein the first thermoplastic material contains one or more colorants.

6. The process of claim 1 wherein the randomized pattern is created by varying the thickness of the second thermoplastic material.

7. The process of claim 1 wherein the one or more colorants is intermittently introduced into the second thermoplastic material.

8. The process of claim 1 wherein one or more colorants is intermittently introduced into the first thermoplastic material.

9. A process of preparing a container comprising blow molding the preform of claim 1.

10. A process of preparing a preform having at least one randomized visual effect, the process comprising:
co-extruding a first layer comprising polyethylene terephthalate and a second layer comprising polyethylene terephthalate and at least one colorant to form a three-layered structure having the configuration A/B/A;
varying at least one of speed, dosage volume, and timing of injection of the second layer so as to form a ribbon or swirl pattern; and
molding the three-layered structure to form a preform having at least one randomized visual effect.

11. The process of claim 10 wherein the second layer is extruded between adjacent layers of the first layer to form the three-layer structure.

12. The process of claim 10 wherein the first layer is extruded between adjacent layers of the second layer to form a three-layer structure.

13. The process of claim 10 wherein the first layer is clear.

14. The process of claim 10 wherein the first layer further comprises one or more colorants.

15. The process of claim 10 wherein the randomized pattern is created by varying the thickness of the second layer.

16. The process of claim 10 wherein the one or more colorants is intermittently introduced into the second layer.

17. The process of claim 10 wherein one or more colorants is intermittently introduced into the first layer.

18. A process of preparing a container comprising blow molding the preform of claim 10.
